(19) United States
(12) Patent Application Publication
(10) Pub. No.: US 2007/0260683 A1
(43) Pub. Date: Nov. 8, 2007

(54) COMPUTER PROGRAM PRODUCT FOR PROVIDING PARALLEL PRESENTATIONS

(75) Inventors: Gregory R. Hintermeister, Rochester, MN (US); Michael D. Rahn, Rochester, MN (US)

Correspondence Address: CANTOR COLBURN LLP - IBM ROCHESTER DIVISION, 55 GRIFFIN ROAD SOUTH, BLOOMFIELD, CT, 06002, US

(73) Assignee: International Business Machines Corporation, Armonk, NY (US)

(21) Appl. No.: 11/381,642

(22) Filed: May 4, 2006

(51) Int. Cl. G06F 12/14; G06F 15/16; G06F 17/00; G06F 17/30; G06F 3/00

(52) U.S. Cl. 709/204; 715/753; 726/21

(57) ABSTRACT

A computer program product for providing presentations to a plurality of individuals includes instructions for creating a plurality of sub-presentations related to a master presentation wherein each sub-presentation comprises a plurality of slides having content customized for each of the participants; distributing the plurality of sub-presentations to each of the respective participants; and displaying each sub-presentation to each of the respective participants as the presentation.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### FIELD OF THE INVENTION

This invention relates to presentation software and particularly to presentations for varying audiences.

### BACKGROUND OF THE RELATED ART

Current web collaboration software allows users to share presentations and demonstrations with multiple participants via the Internet. Unfortunately, current collaboration software only supports showing the same demonstration and presentation pages to all of the participants in a conference. What is needed is a way to provide alternate views to selected recipients.

### SUMMARY OF THE INVENTION

The shortcomings of the prior art are overcome and additional advantages are provided through the provision of a computer program product stored on machine readable media, the product including instructions for providing a presentation to a plurality of participants, the instructions having instructions for: creating a plurality of sub-presentations related to a master presentation wherein each sub-presentation has a plurality of slides having content customized for each of the participants; distributing the plurality of sub-presentations to each of the respective participants; and displaying each sub-presentation to each of the respective participants as the presentation.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which includes, among other things, a computer program product stored on machine readable media, the product including instructions for providing a presentation to a plurality of participants, the instructions having instructions for: creating a plurality of sub-presentations related to a master presentation by selecting content from at least one of common content and specific content wherein each sub-presentation comprises a plurality of slides having the content customized for each of the participants, wherein the content for at least one slide is customized by selecting at least one layer having content; and wherein at least one layer includes a properties layer; associating each sub-presentation with each of the participants; distributing the plurality of sub-presentations to each of the respective participants by providing at least one of the master presentation and each of the sub-presentations to a server, wherein distributing further has at least one of identifying a user ID, identifying an email address, identifying an IP address and receiving authentication information and interfacing with web conferencing software for distributing each sub-presentation during a web conference; and displaying each sub-presentation to each of the respective participants as the presentation by interfacing with web conferencing software for displaying each sub-presentation during a web conference.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of an enhanced user interface for presentation software; and

FIG. 2 illustrates one example of a providing a plurality of presentations to selected participants.

The detailed description explains the preferred embodiments of the invention, together with advantages and features, by way of example with reference to the drawings.

### DETAILED DESCRIPTION OF THE INVENTION

Disclosed herein are enhancements to presentation software. Non-limiting examples of presentation software include Lotus Freelance and Microsoft Powerpoint. The enhancements provide users with capabilities to create customized presentations having alternate sub-presentations including various content. The content is assigned to selected recipients (i.e., participants). When the customized presentation is displayed using web conference software (such as Sametime and NetMeeting), at least some of the participants are presented with certain sub-presentations that are a customized version of the presentation. The teachings herein include enhancements that provide for managing and displaying of sub-presentations and content for the selected participants.

The customized presentations typically include a plurality of slides having content for each of the participants. As formats and other aspects of computer generated presentations are well known, such aspects are generally not discussed further herein.

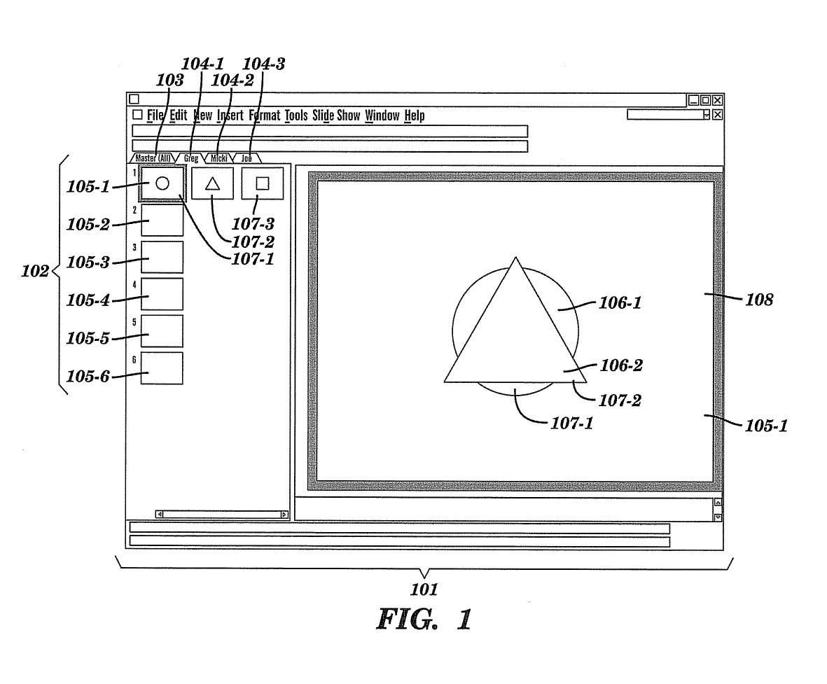

Referring to FIG. 1, there is shown a user interface 101. The user interface 101 includes access to features and functions as are typically called for in presentation software. Typically, a multi-presentation development tool 102 is also included. In the embodiment depicted, the multi-presentation development tool 102 includes a master presentation 103 and a plurality of sub-presentations 104. In this example, participants Greg, Nicki, Joe and Kristi each receive a separate sub-presentation 104 (such as through separate workstations—not shown). In this example, the master presentation 103 and the plurality of sub-presentations 104 are accessed through “tab” features.

Referring to the portion of FIG. 1 depicting the multi-presentation development tool 102, enhancements to presentation software are shown. In this example, the enhancements are integrated with Microsoft PowerPoint from Microsoft Corporation. The multi-presentation development tool 102 provides enhancements that allow authors of presentations to create a plurality of sub-presentations 104 having varying content. For example, the multi-presentation development tool 102 typically includes a series of thumbnail graphics indicative of the content for each sub-presentation 104 within the plurality of sub-presentations 104.

In this embodiment, each thumbnail represents a slide 105 for each of the sub-presentations 104. Referring to FIG. 1, and the sub-presentation 104-1 for Greg, a first slide 105-1 includes a first layer 107-1 and a second layer 107-2. A third layer 107-3 is not turned on for Greg. It may be noted that, in this example, an enunciator in a top left hand corner of each thumbnail indicates whether one of the layers 107 is turned on or off for the respective sub-presentation 104.

The thumbnails displayed in the multi-presentation development tool 102 provide alternate content 106 that can replace or augment each slide 105. For example, to create a sub-presentation 104-1 for Greg, the user need only click on the Greg tab and toggle visibility on or off for each layer 107-1, 107-2, 107-3 associated with a respective slide 105 (shown as a first slide 105-1). Typically, creation of the sub-presentation 104 simply calls for reviewing the plurality of layers 107 associated with each slide 105, and selecting each one of the layers (107-1, 107-2, 107-3) for an on or off state.

Referring also to FIG. 1, the user interface 101 typically includes a preview window 108, also referred to as an editing pane 108 or simply a window 108. In this example, the preview window 108 provides a display of the first slide 105-1. Each layer 107 that is included in each slide 105 includes some form of content 106. For simplicity, content 106 is indicated herein by various geometric shapes.

In this example, during the sub-presentation 104-1, Greg will see a circle (common content 106-1 for all participants) with a triangle (specific content 106-2 for Greg) in the first slide 105-1. Other participants, such as Nicki and Joe, might only see the circle (the common content 106-1). Toggling each layer (107-1, 107-2, 107-3) in the plurality of layers 107 is determinative of the content 106 available to each participant.

Typically, a number of sub-presentations 104, a number of slides 105, and a number of layers 107 are open to determination by the presentation developer. Accordingly, although this illustration depicts three sub-presentations (104-1, 104-2, 104-3), six slides (105-1, 105-2, 105-3, 105-4, 105-5, 105-6) and three layers (107-1, 107-2, 107-3), these numbers are merely illustrative and are not limiting of the teachings herein. Known techniques are typically used for addition of sub-presentations 104, slides 105 and layers 107.

Referring to the presentation 103, typically, aspects (in this example, layers 107) of each sub-presentation 104 can be made visible or invisible as indicated by a small icon in the upper left corner of each of the thumbnails. Content 106 can be added, removed, and made visible and invisible via a context menu (not shown) to the various layers 107 using known techniques, such as such as bar menus and context menus (not shown).

Typically, exemplary context menus and bar menus take advantage of known programming techniques and features for graphical user interface displays. Non-limiting examples include pop-up menus, tab features, right-click menus and pull down menus. As interface tools are well known, these are generally not discussed further herein.

Typically, the presenter refers to the master presentation 103 for defining default sub-presentations 104, slides 105 and layers 107. In this embodiment, three sub-presentations 104 have been defined and are referenced by use of tabs. The sub-presentations 104 are specifically defined for participants Greg, Nicki, and Joe. These participants will see customized versions of the presentation 103. For example, each participant will see a customized sub-presentation 104 having a unique a first slide 105 (as indicated by the circle, triangle and square) during the same Web conference. In this embodiment, each sub-presentation 104 (i.e., custom tab) is associated with a given conference participant. The association may occur by making use of user ID, email address, IP address, or by whatever technique is desired. Typically, the association occurs when each participant signs in for the presentation 103.

One skilled in the art will recognize that although this type of enhancement is particularly amenable to systems for implementation with web conferencing tools, the teachings herein are not limited as such. For example, the teachings herein could be implemented in multiple classrooms with projectors, in a local network, or in a time-independent basis (such as for self learning tools where a variety participants sign on to a single, stand-alone system for similar self-taught training sessions).

An example of adding content is provided in FIG. 1. Referring to FIG. 1, the illustration shows that a tab for Greg is selected. In this example, a plurality of layers 107 for the first slide 105-1 are made visible to Greg, and present the associated content 106.

Using this example, one skilled in the art can understand that content 106 may be presented in a versatile and flexible manner. That is, aspects of each sub-presentation 104 may be called upon as an information resource for another sub-presentation 104. For example, in some embodiments, a presenter may use specific content 106-2 for one participant at one point, while using the same specific content 106-2 at another point for a different participant. Although the same may be accomplished with common content 106-1, typically, the presenter merely turns common content 106-1 on and off for each participant.

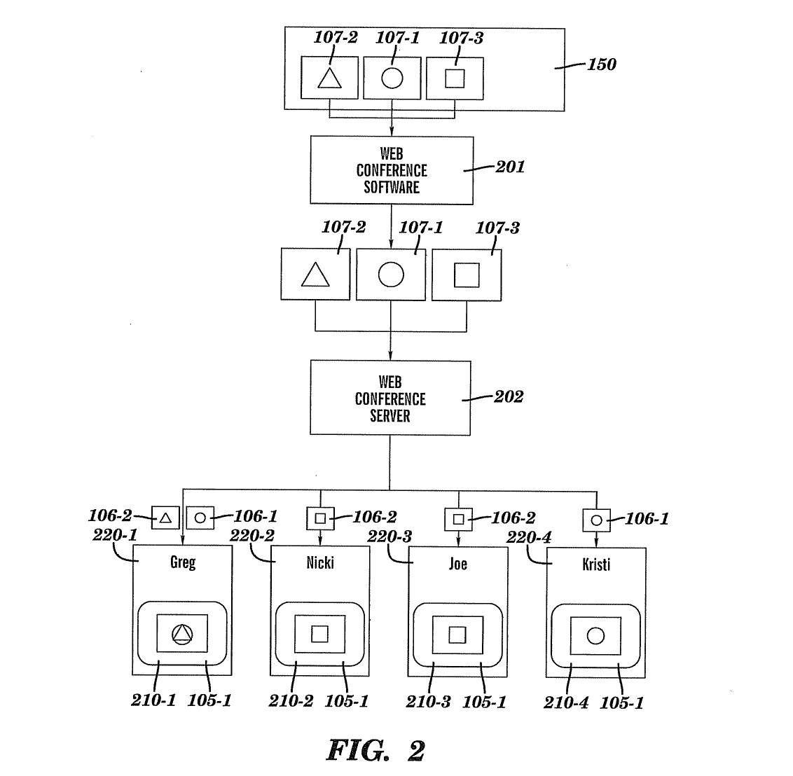

Referring now to FIG. 2, exemplary techniques for displaying the customized presentation 103 in a Web conference are now provided. In this example, Web conference software 201 (such as Lotus Sametime) is used to distribute a plurality of sub-presentations 104 to a plurality of user displays 210 for a plurality of participants 220.

In this embodiment, enhanced presentation software 150 sends all three sub-presentations 104 to Web conference software 201, typically installed on the presenter's computer. Typically, the presentation software 150 and the Web conference software 201 together provide for control over the distribution of the presentation 103 and each sub-presentation 104. As an example, the Web conference software 201 sends each sub-presentation 104 and participant information to a Web conference server 202. The server 202 determines which sub-presentation 104 is to be associated with a given participant 220 and provides for proper distribution. In some embodiments, the server 202 is a part of a network, such as the Internet.

In one embodiment, the conference software 201 sends an entire presentation 103 including all of the slides 105 to the server 202. In another embodiment, the conference software 201 sends slides 105 or sub-presentations 104 only for the participants signed into the meeting, thus providing faster presentation and improved data security.

In the example of FIG. 2, the server 202 sends Greg a first sub-presentation 104-1. The first sub-presentation 104-1 includes the first layer 107-1 and the second layer 107-2 for the first slide 105-1 (as defined in the sub-presentation 104). Nicki sees a second sub-presentation 104-2 and Joe sees a third sub-presentation 104-3. Nicki and Joe see a third layer 107-3 for the first slide 105-1, the third layer 107-3 having been defined in the sub-panel for their respective sub-presentation 104-2, 104-3. In this embodiment, the server 202 sends Kristi default information as her sub-presentation (that is, the common content 106-1) since there is no customized view for her.

One skilled in the art will recognize that the terms “layers” and “sub-presentations” as well as other terms may present certain similarities. That is, for example, in the enhanced presentation software 150, various information storage and retrieval techniques may be used, and depending on the formats and the structures certain similarities or duplications may exist. Therefore, the teachings herein are merely illustrative of techniques for making similar presentations using enhanced presentation software 150, and are not limiting thereof.

In another embodiment, peer-to-peer Web conference software (such as Microsoft NetMeeting) is used to distribute each sub-presentation 104 of the customized presentation. The enhanced presentation software 150 sends all three sub-presentations 104 to the Web conference software 202, with instructions or information regarding which participants 220 to be provided each of the sub-presentations 104. The Web conference software 202 manages the slides 105 for each of the participants 220 and provides sub-presentations 104 accordingly.

A further embodiment accounts for the fact that presentations are often sent directly to remote participants 220 who, for various reasons, cannot conference in. Accordingly, in another embodiment, the enhanced presentation software 150 supports sending the presentation 103 and the sub-presentation 104 directly to a participant 220 while maintaining customized views. Typically, any one of three ways is used.

For example, direct sending of the sub-presentation 104 may involve exporting the sub-presentation 104 to a user file that includes the customized view of the remote participant 220; sending the entire presentation to the remote participant 220 but requiring users to provide a respective user ID and a password to unlock their customized view; and a combination of both exporting a customized view and requiring authentication. Of course, other known techniques for exporting data may be used advantageously, and these are merely examples and non-limiting. In one example, the user enters authentication information to access one of the exported master presentation and the exported sub-presentation. In another example, the user is authenticated in the background as the enhanced presentation software 150 automatically checks and registers network authentication information (such as a workstation identification).

The features described above allow presentation authors to create presentations with customized content 106. The content 106 is protected from participants 220 as deemed appropriate by the presenter. The complete presentation 103 or portions thereof can be sent via email, and customized sub-presentations 104 and aspects thereof can be preserved. Typically, any person opening the presentation 103 must identify themselves, and when properly identified, selected content 106 is revealed as appropriate.

The teachings herein also provide for a “hidden” properties layer 107 that captures authorship and other such information. One problem with presentations is that original authorship is not well preserved. With this invention, each contributor could add the properties layer 107 recording who's idea was what, when it was originally created, etc, . . . The hidden information could be associated on a per-slide or other basis. In these embodiments, no matter who presents the material, or who copies the page to insert into their pitch, there is a hidden layer associated with the main page. Individual layers, even entire slides could be locked down, allowing only specific users to view, modify, or copy the associated content 106.

The capabilities of the present invention can be implemented in software, firmware, hardware or some combination thereof. As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A computer program product stored on machine readable media, the product comprising instructions for providing a presentation to a plurality of participants, the instructions comprising instructions for:
creating a plurality of sub-presentations related to a master presentation wherein each sub-presentation comprises a plurality of slides having content customized for each of the participants;
distributing the plurality of sub-presentations to each of the respective participants; and
displaying each sub-presentation to each of the respective participants as the presentation.

2. The computer program product of claim 1, wherein each sub-presentation comprises at least one of common content and specific content.

3. The computer program product of claim 1, wherein creating each sub-presentation comprises selecting one of common content and specific content for each participant.

4. The computer program product of claim 1, wherein creating each sub-presentation comprises associating each sub-presentation with each of the participants.

5. The computer program product of claim 1, wherein distributing comprises providing at least one of the master presentation and each of the sub-presentations to a server.

6. The computer program product of claim 1, wherein distributing further comprises at least one of identifying a user ID, identifying an email address, identifying an IP address and receiving authentication information.

7. The computer program product of claim 1, wherein the content for at least one slide is customized by selecting at least one layer comprising content.

8. The computer program product of claim 7, wherein at least one layer comprises a properties layer.

9. The computer program product of claim 1, wherein distributing further comprises interfacing with web conferencing software for distributing each sub-presentation during a web conference.

10. The computer program product of claim 1, wherein displaying further comprises interfacing with web conferencing software for displaying each sub-presentation during a web conference.

11. The computer program product of claim 9, wherein the web conferencing software is one of server based software and peer-to-peer software.

12. The computer program product of claim 10, wherein the web conferencing software is one of server based software and peer-to-peer software.

13. The computer program product of claim 1, further comprising instructions for exporting at least one of the master presentation and a sub-presentation to a file.

14. The computer program product of claim 13 further comprising instructions for entering authentication information to access one of the exported master presentation and the exported sub-presentation.

15. A computer program product stored on machine readable media, the product comprising instructions for providing a presentation to a plurality of participants, the instructions comprising instructions for:
creating a plurality of sub-presentations related to a master presentation by selecting content from at least one of common content and specific content wherein each sub-presentation comprises a plurality of slides having the content customized for each of the participants, wherein the content for at least one slide is customized by selecting at least one layer comprising content; and wherein at least one layer comprises a properties layer;
associating each sub-presentation with each of the participants;
distributing the plurality of sub-presentations to each of the respective participants by providing at least one of the master presentation and each of the sub-presentations to a server, wherein distributing further comprises at least one of identifying a user ID, identifying an email address, identifying an IP address and receiving authentication information and interfacing with web conferencing software for distributing each sub-presentation during a web conference; and
displaying each sub-presentation to each of the respective participants as the presentation by interfacing with web conferencing software for displaying each sub-presentation during a web conference.
